(19) United States
(12) Patent Application Publication
(10) Pub. No.: US 2017/0015528 A1
(43) Pub. Date: Jan. 19, 2017

(54) Grapple Assembly

(71) Applicant: Marcus Jay Ferguson, Canton, MI (US)

(72) Inventor: Marcus Jay Ferguson, Canton, MI (US)

(21) Appl. No.: 15/184,402

(22) Filed: Jun. 16, 2016

Related U.S. Application Data
(60) Provisional application No. 62/193,103, filed on Jul. 16, 2015.

(51) Int. Cl. B66C 1/58

(52) U.S. Cl. CPC B66C 1/585

(57) ABSTRACT

A grapple assembly for a small tractor, which uses the John Deere front mounted quick hitch system in which the existing angular position cylinder of the quick hitch is repositioned so as to open and close the upper jaw of said grapple. The grapple assembly is compatible with small tractors that utilize the John Deere front mounted quick-hitch as a means to powerfully grasp and lift logs, rocks, boulders, brush, branches, limbs and many other objects, and transport and deposit these objects to a new location with virtually no tools and no physical effort by the operator. The grapple assembly is used for transporting, lifting and holding logs and limbs for cutting.

### CROSS-REFERENCE TO RELATED APPLICATIONS

This Application is related to U.S. Provisional Application No. 62/193,103, entitled “Grapple Attachment for Tractor” invented by Marcus Jay Ferguson, filed on Jun. 16, 2015, now abandoned.

### FIELD OF USE

The present invention relates to a grapple assembly, and in particular, a grapple assembly that is compatible with a quick-hitch mounting system to operate front-mounted implements on a tractor.

### BACKGROUND OF THE INVENTION

John Deere quick hitches are designed to interface with a snow/dirt blade (plow), a snow blower, a rotary sweeper, and a plow shovel.

There are many various attachments available to the owner of small yard tractor, with a grapple assembly seemingly lacking. While there are many grapple attachments available for larger tractors and skid steer vehicles, there are not any specifically made for the smaller John Deere® tractors typically found in use by private individuals.
U.S. Pat. No. 8,109,709 (Gaetze) discloses a removable grapple apparatus for a loader bucket is disclosed, and comprises a grapple assembly comprising at least one grapple arm having an inboard end and an outboard end, and a grapple fork mounted on the grapple arm toward the outboard end thereof. The apparatus includes a mounting assembly configured to removably mount the grapple assembly to the bucket when the mounting assembly is mounted on the bucket. The grapple assembly is pivotally mounted on the mounting assembly to permit pivot movement of the grapple assembly with respect to the mounting assembly. The apparatus includes a grapple movement assembly configured to pivotally move the grapple assembly with respect to the mounting assembly
U.S. Pat. No. 7,934,758 (Stamey, et al.) discloses a connecting and adapting system for interconnecting a pair of jaws of a grapple assembly and for adapting the grapple assembly for connecting to a plurality of linkages. The system includes bearings, where the bearings have a flange, an elongated section, and a bore. The flange of the bearings abuts a portion of one of the jaws, the elongated section of the bearings interconnects the jaws, and the bore of the bearing receives a pin to provide a connecting location. A portion of the bearing, being positioned opposite the flange, receives a collar that abuts a portion of one of the jaws. This prior art discloses only reinforced certain parts of the magazine, such as the feed lips or the lockup points. Also, some of this prior art relies on heavy polymers in the areas of the most stress.
U.S. Pat. No. 6,601,891 (Gregory, Jr.) discloses a grapple attachment is presented for use with motorized vehicles. The grapple attachment is comprised of upper and lower jaws having a plurality of elongated, substantially angular tines that are adapted for dislodging, lifting and carrying whole concrete slabs, vertically disposed posts, horizontally disposed logs, rocks and other awkward debris. The tines are further adapted for use in scarifying and ripping ground surfaces. The upper and lower jaws are pivotally connected to each other at the rearward ends thereof, thus forming the body of the grapple. A single actuator moves the grapple jaws between open and closed positions. The grapple is pivotally connected to the front-end loader using a universal hitch that is adapted for use on a plurality of motorized vehicles, including front-end loaders, skid loaders, tractors, backhoes, excavators and end loaders.

What is needed is a grapple assembly that utilizes the John Deere quick-hitch and hydraulic cylinder, which can then be raised and move a heavy object as needed. John Deere® is a registered trademark of the Deere & Company of Moline Ill.

What is needed is a grapple assembly which is compatible with a quick hitch system, such as the John Deere quick hitch system, that is essentially toolless and easily attached with a minimum of effort. This system is a universal mounting system which enables the use of any attachment made by John Deere or other third party manufacturers.

What is needed is a grapple assembly compatible with small tractors that utilize the John Deere front mounted quick-hitch as a means to powerfully grasp and lift logs, rocks, boulders, brush, branches, limbs and many other objects, that can be used for lifting, and transporting and depositing objects to a new location with virtually no physical effort by the operator.

### SUMMARY OF THE INVENTION

The grapple assembly of the present invention addresses the aforementioned needs.

The grapple assembly of the present invention is a small grapple which is designed to be used with the John Deere® quick hitch system found on many small tractors used by homeowners and small contractors. The system enables the attachment of different implements ranging from blades for snow removal to material handling devices such as forks or drum carriers.

The grapple assembly of the present invention is designed for front mounting and attachment to a quick hitch of a tractor or tractor-like vehicle.

The grapple assembly comprises an upper and lower jaw, which oppose each other, and a cylinder mount.

The grapple assembly mounts to the universal quick hitch and provides a cylinder mount to allow for the angling cylinder, hereafter referred to as the grapple hydraulic cylinder, to rotate the grapples upper jaw relative to the lower jaw.

The upper jaw is rotated using the existing hydraulics and repositioned cylinder, to engage the lower jaw, the upper jaw is attached to the lower jaw by one or more pins, the one or more pins enabling the upper jaw to rotate relative to the lower jaw. The one or more rods engage into a pair of slots located on each side of the quick hitch of the vehicle.

A cylinder mount is secured onto the quick hitch. The cylinder mount engages with a grapple hydraulic cylinder. The grapple hydraulic cylinder has two ends. The second end of the grapple hydraulic cylinder is secured to the upper jaw.

The upper jaw opens relative to the lower jaw via the grapple hydraulic cylinder to allow the grapple to be moved onto an object. The upper jaw then closes relative to the lower jaw via the grapple hydraulic cylinder to tightly grasp the object. The object can then be relocated using the vehicle.

John Deere has manufacturing garden tractors and sub-compact utility tractors since the mid 1980's which utilize the quick hitch mounting system. The quick hitch mounting system is a system for mounting various implements—all of which are made by John Deere as well as other third-party manufacturers. These implements include a snow blower, rotary broom (sweeper), blade (plow), and plow shovel (a device that attaches to the blade to enable the blade to be used as a bucket for scooping, moving and lifting various loose materials, such as mulch, dirt, snow, etc.).

As used herein the term “quick hitch” refers to quick hitches that are designed to interface with a snow/dirt blade (plow), a snow blower, a rotary broom (sweeper), and a plow shovel and utilize a linear actuator, such as a hydraulic cylinder to actuate these implements. Such power sources are readily available in the industry such as those produced by John Deere. The grapple assembly of the present invention is compatible with John Deere® quick hitches: BM1821, BM17347, BM19782, BM20921, BM18122, BM18644, BLV10159, BM26047, BM24898 and with minor modification is compatible with other manufacture of quick hitches.

For a complete understanding of the grapple assembly of the present invention, reference is made to the accompanying drawings and description in which the presently preferred embodiments of the invention are shown by way of example. As the invention may be embodied in many forms without departing from spirit of essential characteristics thereof, it is expressly understood that the drawings are for purposes of illustration and description only, and are not intended as a definition of the limits of the invention.

### BRIEF DESCRIPTION OF THE DRAWINGS

FIGS. 1 and 2 depict an assembly view of the preferred embodiment of a grapple assembly of the present invention attached to the quick hitch, the grapple assembly having the grapple jaws open.

FIGS. 3 and 4 depict an assembly view of the preferred embodiment of the grapple assembly of FIGS. 1 and 2 attached to the quick hitch, the grapple assembly having the grapple jaws closed.

FIG. 5 depicts an isometric view of the grapple assembly of FIGS. 3 and 4, the grapple hydraulic cylinder being shown in phantom, absent the quick hitch, the grapple assembly having the grapple jaws closed.

FIG. 6 depicts a side view of the grapple assembly of FIGS. 1 and 2, the grapple hydraulic cylinder being shown in phantom, absent the quick hitch, the grapple assembly having the grapple jaws open.

FIG. 7 depicts a side view of the grapple assembly of FIG. 5, the grapple hydraulic cylinder being shown in phantom, the grapple assembly having the grapple jaws closed.

FIG. 8 depicts an isometric view of the upper jaw of FIG. 5 of the grapple assembly of the present invention.

FIG. 9 depicts an isometric view of the lower jaw of FIG. 5 of the grapple assembly of the present invention.

FIG. 10 depicts an isometric view of the hydraulic cylinder mount of FIG. 5 of the grapple assembly of the present invention.

FIG. 11 depicts an assembly view of the grapple assembly of FIG. 2, the grapple assembly having the grapple jaws closed.

FIG. 12 depicts an assembly view of the grapple assembly of FIG. 1, the grapple assembly having the grapple jaws open.

FIG. 13 depicts a side of the grapple assembly of FIG. 11, the grapple assembly having the grapple jaws closed.

FIG. 14 depicts a side of the grapple assembly of FIG. 12, the grapple assembly having the grapple jaws open.

FIG. 15 depicts a side of the grapple assembly of FIG. 2 attached to the quick hitch, the grapple assembly having the grapple jaws closed.

FIG. 16 depicts a side of the grapple assembly of FIG. 1 attached to the quick hitch, the grapple assembly having the grapple jaws open.

FIGS. 17A, 17B, and 17C depict a side view of the present invention connected to the quick hitch being used to grab an object.

FIGS. 18 and 19 depict two different assembly views of a simplified quick hitch which is attached to the grapple assembly of the present invention of FIGS. 1, 2, 3, and 4.

FIG. 20 depicts an assembly view of the grapple assembly of FIG. 1, the grapple assembly having the grapple jaws open.

### DETAILED DESCRIPTION OF THE PREFERRED EMBODIMENTS

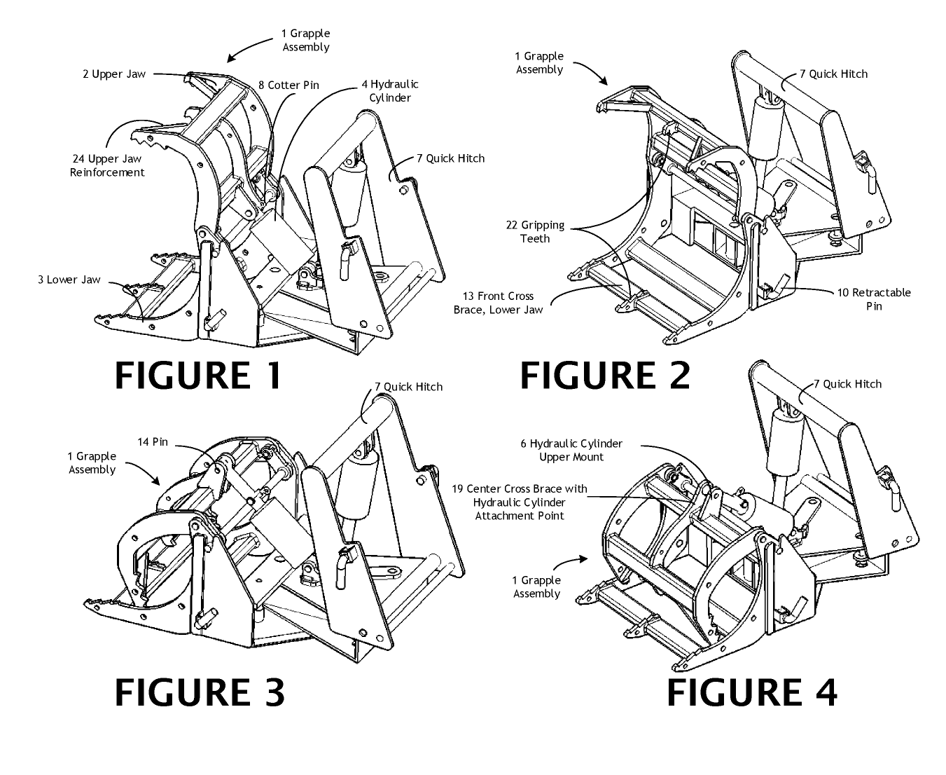

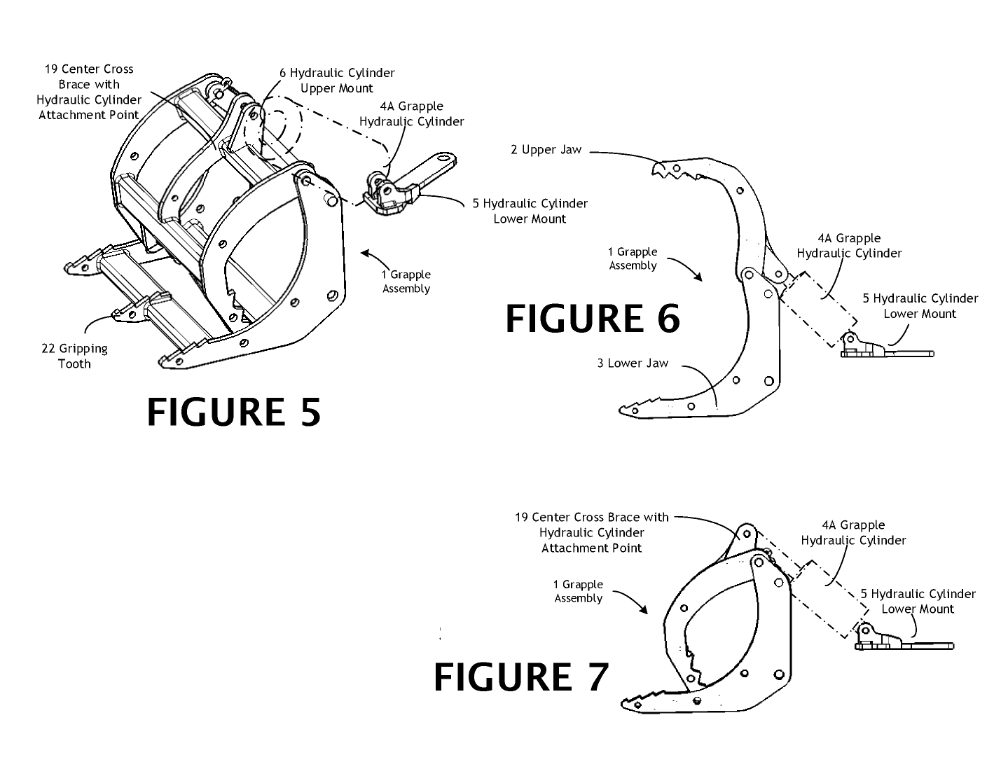

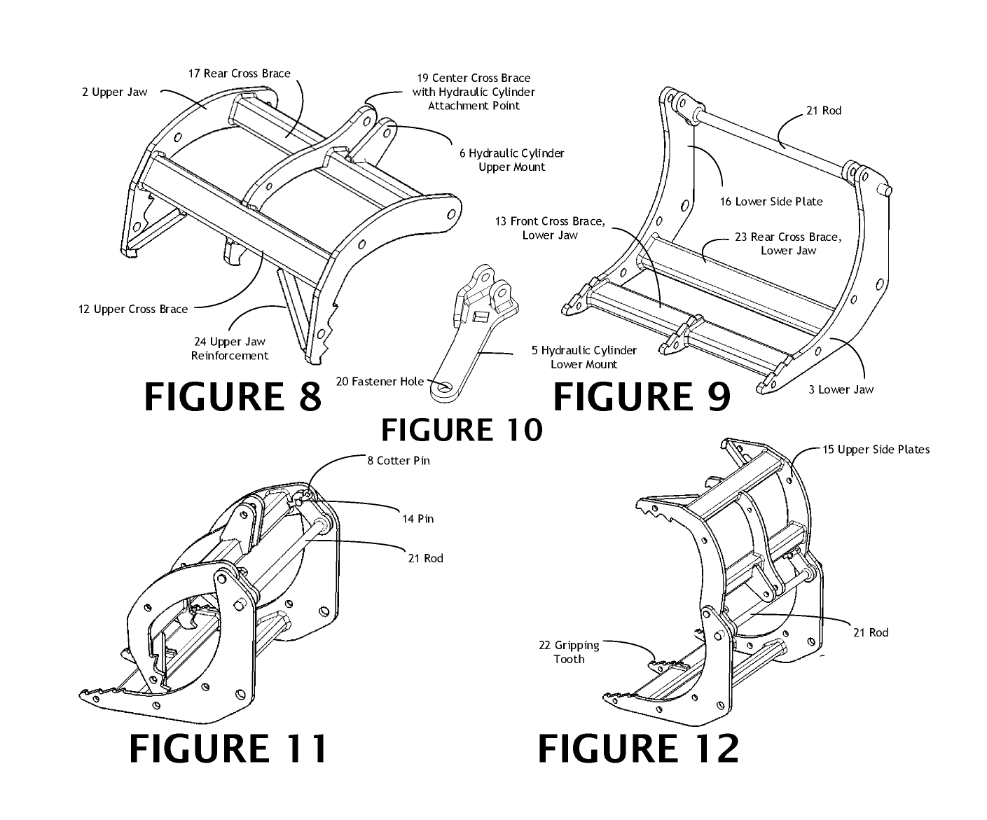

Referring now to the drawings, FIGS. 1, 2, 3, and 4 depict various isometric views of the grapple assembly [1] of the present invention as depicted attached to a John Deere quick hitch [7], with the jaws either open or closed. The grapple assembly of the present invent includes an upper jaw [2], a lower jaw [3] and lower hydraulic cylinder mount [5]. The upper jaw [2] and the lower jaw [3] each include side plates made from laser cut steel. The upper jaw [2], comprises two upper side plates [15] which are attached to the upper front cross brace [17], and upper rear cross brace [12]. At the ends of the side plates [15] are upper jaw support brackets [24] which are welded into place to add more rigidity to the gripping surface of the upper jaw [2]. Instead of the support brackets [24], a straight tube can be used. Attached to the middle of the upper front and rear cross brace [17 and 18] is the center cross brace for the upper jaw [19] which also part of the hydraulic cylinder [4] mount attached. Welded onto the rear cross brace for the upper jaw [18] next to the center cross brace for the upper jaw [19] is the other half of the upper hydraulic cylinder [4] mount [6].

The hydraulic cylinder [4] which opens and closes the upper jaw [2] is attached at this point via two pins [14] and secured with cotter pins [8]. The lower hydraulic cylinder mount [5] is attached to the John Deere quick hitch mount and the lower part of the hydraulic cylinder [4] is attached. The hydraulic cylinder [4] is the lower cylinder of the quick hitch [7] which is normally used to move various implements from side to side, but in this application, is relocated so as to be used to open and close the upper jaw of the grapple assembly. Not all quick hitches come with the extra hydraulic cylinder to move the implements from side to side. This option is normally standard when using the snow blower attachment and the cylinder can be purchased separately if needed.

The grapple cylinder lower mount [5] is used to alter the angle of grapple hydraulic cylinder [4A] of the grapple assembly [1] of the present invention and is secured to the quick hitch [7]. This enables the upper jaw of the grapple assembly to open and close to grasp various objects (logs, rocks, brush, etc.). The quick hitch [7] can then be raised and the object moved to a new location. The proprietary concepts of this design include the concept of relocating an existing grapple hydraulic cylinder [4A] to provide the opening and closing function of the opposing grapple jaws [2 and 3].

This grapple hydraulic cylinder [4A] is relocated and becomes the method for opening and closing the upper opposing jaw [2] of the grapple assembly [1].

Once installed on the quick-hitch [7], these opposing jaws [2 and 3] can be raised and lowered by the up/down cylinder on the quick-hitch [7] and opened and closed by the relocated grapple hydraulic cylinder [4A]. This device can then be used to powerfully grasp and lift logs, rocks, boulders, brush, branches, limbs and many other objects.

Once lifted, they can be transported and deposited in a new location. The grapple assembly [1] of the present invention can be used for transporting, lifting and holding logs and limbs for cutting.

A grapple cylinder lower mount [5] bolts to the quick-hitch [7] to hold the relocated grapple hydraulic cylinder [4A]. This grapple cylinder lower mount [5] comprises a bottom plate and 2 tabs welded together with opposing holes that enable the end of the grapple hydraulic cylinder [4A] to attach with a pin. This grapple cylinder lower mount [5] attaches to the quick hitch [7] with either a carriage bolt and pin or even 2 pins. This hardware is provided with the grapple assembly [1] of the present invention. Since the quick hitch [7] has the ability to angle for the blade and the sweeper, it has a locking feature designed in (by John Deere) to enable a pin to be inserted that will lock the front section of the quick hitch [7] from rotating. Since the grapple assembly [1] does not rotate side to side (which is also not desired), this grapple cylinder lower mount [5] attaches to the quick hitch [7] using the anti-rotation hole so that the pin or carriage bolt will both secure the bracket to the hitch as well as lock the front section from rotating (killed 2 birds with 1 stone kind of thing). The John Deere hydraulic cylinders used by the quick hitch have 4 inches of total travel. They are 8″ when closed and 12″ when open. One primary challenge in designing the grapple assembly [1] of the present invention is to arrange the pivot points in such a way as to enable the necessary rotation of the upper opposing jaw [2] in order to be able to open far enough to grab large objects as well as to close completely shut for small objects.

The cylinder mounting points (on both ends) and the pivot points on the upper jaw have been creatively positioned to accomplish this challenging design criteria.

It was also necessary in redesigning the configuration so that the relocated grapple hydraulic cylinder [4A] is not pinched or crushed when the quick-hitch [7] is raised by the hitch hydraulic cylinder [4B].

The grapple hydraulic cylinder [4A] is relocated to the location shown and attaches to the grapple cylinder lower mount [5] that bolts to the quick hitch [7]. The grapple hydraulic cylinder [4A] also attaches to the upper jaw [2] for opening and closing.

The grapple cylinder lower mount [5] mounts to the quick hitch [7] using an existing hole in the quick hitch [7]. This hole is normally used to put an anti-rotation pin (or bolt) into when the angling cylinder is not used (using a snow blower). The bolt will come with my grapple assembly and serves a dual purpose to attach the bracket and provide anti rotation to the quick hitch much like the snow blower. The angling function is not needed or desired when using the grapple assembly [1] of the present invention.

The grapple hydraulic cylinder [4A] that is relocated to operate the upper opposing jaw has 4 inches of total travel (pivot to pivot). It is 12 inches when extended and 8 inches when contracted. The pivot points of the grapple assembly [1] have been designed such that the upper opposing jaw [2] is in a closed position when the grapple hydraulic cylinder [4A] is completely extended and will rotate 90 degrees open as the grapple hydraulic cylinder [4A] contracts to 8 inches.

The lower hydraulic cylinder mount [5] is attached to the quick hitch [7] via two holes [20] located on the quick hitch [7]—depicted in FIG. 10—the front most being the hole used to locate an anti-rotation pin when using a snow-blower and other similar attachments which do not use the hydraulic cylinder [4] used to move implements side to side. The bolt used to secure the lower hydraulic cylinder mount [5] replaces the anti-rotation pin which is normally used to lock the quick hitch [7] place.

To attach the grapple assembly [1] of the present invention to the quick hitch [7], the grapple assembly [1] is aligned with the quick hitch [7] and the quick hitch [7] is lowered and the tractor driven forward until the upper mounting slot [11] on the quick hitch [7] is aligned with the steel rod [21] which spans the width of the upper part of the lower jaw [3] of the grapple assembly [1]. Alternatively, in another preferred embodiment a rod [21] preferably made of steel or the like disposed on the grapple assembly [1] slides into a slot [11] disposed on the quick hitch [7] (on each side). The quick hitch [7] is then raised and the lower part of the grapple jaw [2] is attached to the lower part of the quick hitch [7] via a retractable pin [10] located on each side of the quick hitch [7]. Once this is done, the hydraulic cylinder [4] is then attached to the upper and lower mounts [5 and 6].

The lower hydraulic cylinder mount [5] is secured to the quick hitch using an existing hole in the quick hitch [7]. This hole is normally used to insert an anti-rotation pin or bolt into when the angling cylinder is not used e.g.—using snow blower. The bolt will come with the grapple assembly [1] pf the present invention and serves a dual purpose to attach the lower hydraulic cylinder mount [5] and provide anti-rotation to the quick hitch [7] (like the snow blower), the angling function is not needed or desired when using the grapple assembly [1] of the present invention.

FIG. 5 is an assembly depiction of the grapple assembly [1] of the present invention, and lower hydraulic cylinder mount [6] of the present invention not mounted on the John Deere quick hitch [7]. FIGS. 6, and 7 are side views of the grapple assembly [1] and lower hydraulic cylinder mount [6] of the present invention with the FIG. 6 depicting the grapple assembly [1] with the upper jaw [2] in the open position, while FIG. 7 is a depiction of the grapple assembly [1] with the upper jaw [2] in the closed position.

FIGS. 8 and 9 depict an assembly view of the upper and lower jaws [2, 3] respectively while FIG. 10 is the lower hydraulic cylinder mount [5]. FIGS. 11 and 12, show the assembled grapple [1]. In this view, it is possible to see how the upper jaw [2] is attached to the lower jaw [2] via two pins [14]. These pins [14] are held in place via a cotter pin [8]. This makes assembly and disassembly for maintenance very easy, as well as tool free, without comprising durability and strength.

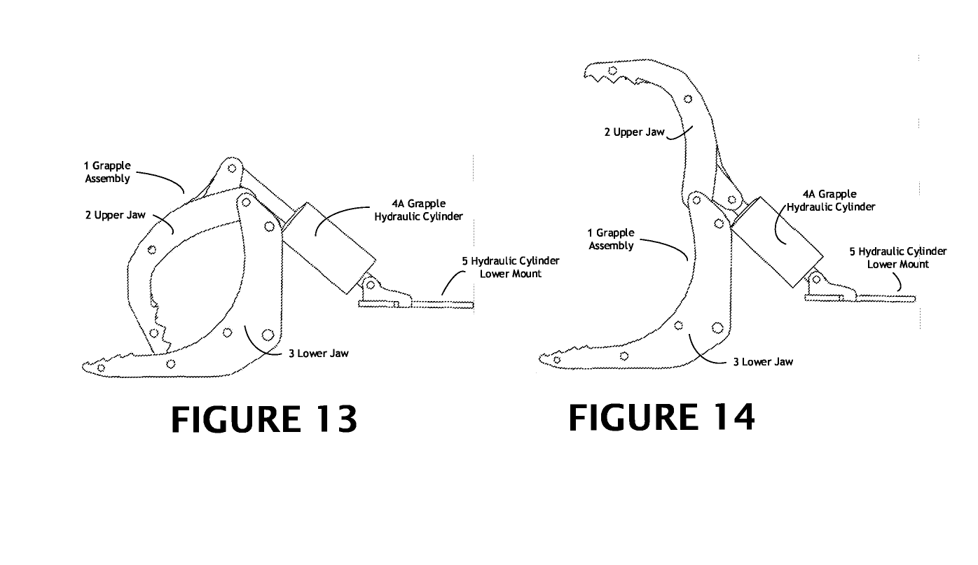

FIGS. 13, and 14 depict a side view of the assembled grapple assembly [1] and attached cylinder [4]. In FIG. 13, the upper jaw [2] is closed, and FIG. 14, the upper jaw [2] is open. The cylinder [4] is attached to the upper jaw [2] and the lower mount [6]. During operation, the cylinder stays in the same position with only the piston moving and the upper jaw [2] opening, or closing.

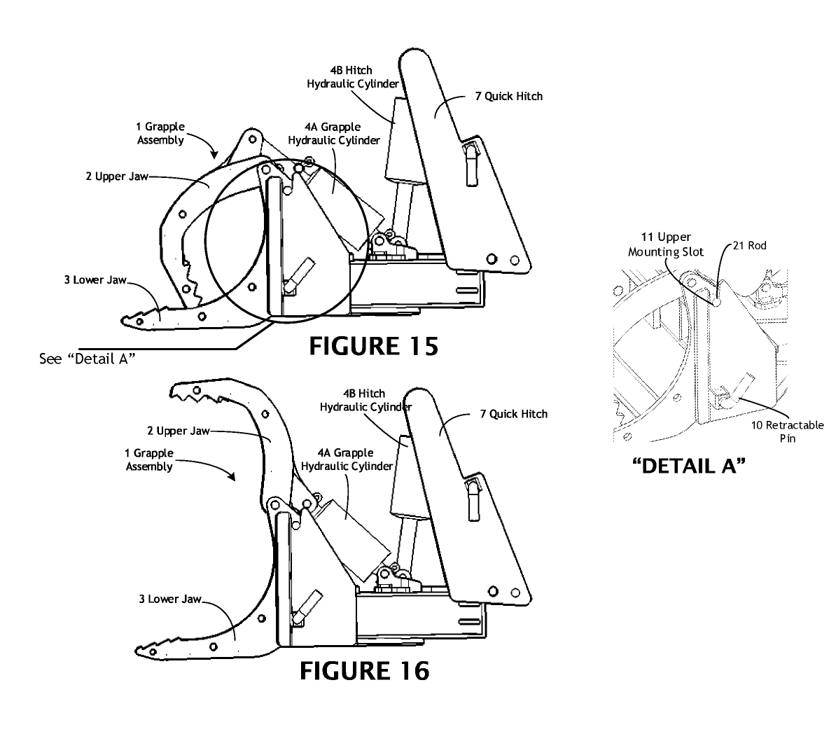

FIG. 15 depicts a side of the grapple assembly of FIG. 2 attached to the quick hitch, the grapple assembly [1] having the grapple jaws [2 and 3] closed. And, FIG. 16 depicts a side of the grapple assembly of FIG. 1 attached to the quick hitch, the grapple assembly [1] having the grapple jaws [2 and 3] open. “DETAIL A” is an exploded view from FIG. 15 and depicts a rod [21] in the grapple assembly [1] of the present invention meshing into an upper mounting slot [11] in the quick hitch [7].

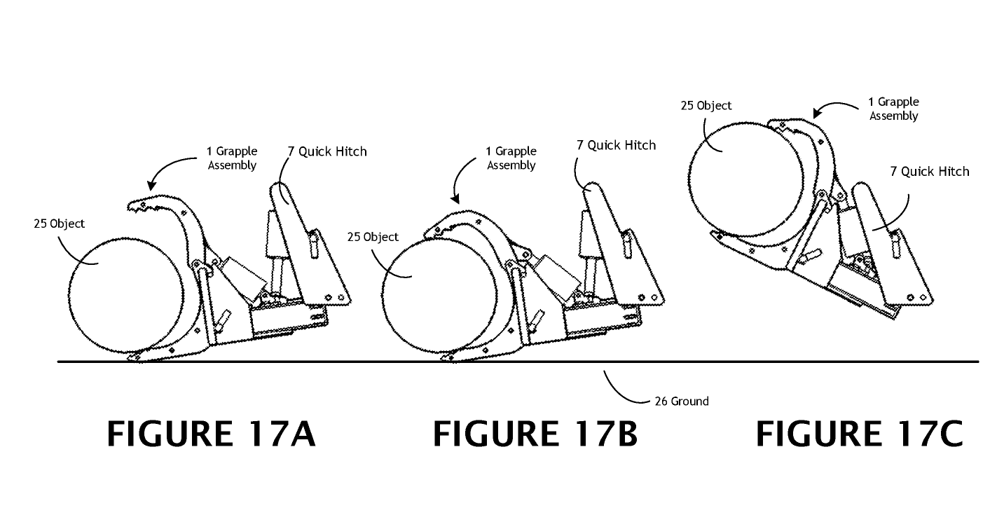

FIGS. 17A, 17B, and 17C depict the side view of the grapple assembly [1] of the present invention as it appears while grabbing and object [25]. To grab an object [25] (FIG. 17A) relative to the ground [26] the user moves the grapple assembly [1] down (FIG. 17B) and opens the upper jaw [2], then drives the tractor forward until the object is positioned far enough onto the lower jaw [3]. The upper jaw [2] is then closed and the grapple assembly [1] then raised (FIG. 17C) the object [25] relative to the ground [26].

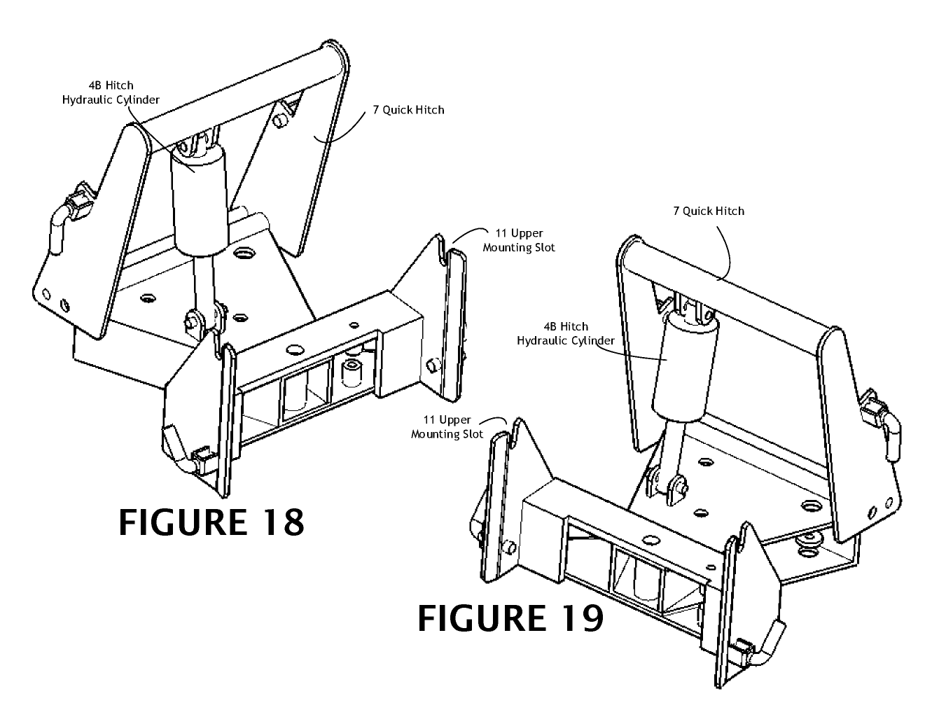

FIGS. 18 and 19 depict two different assembly views of a simplified quick hitch [7] which is attached to the grapple assembly [1] of the present invention of FIGS. 1, 2, 3, and 4.

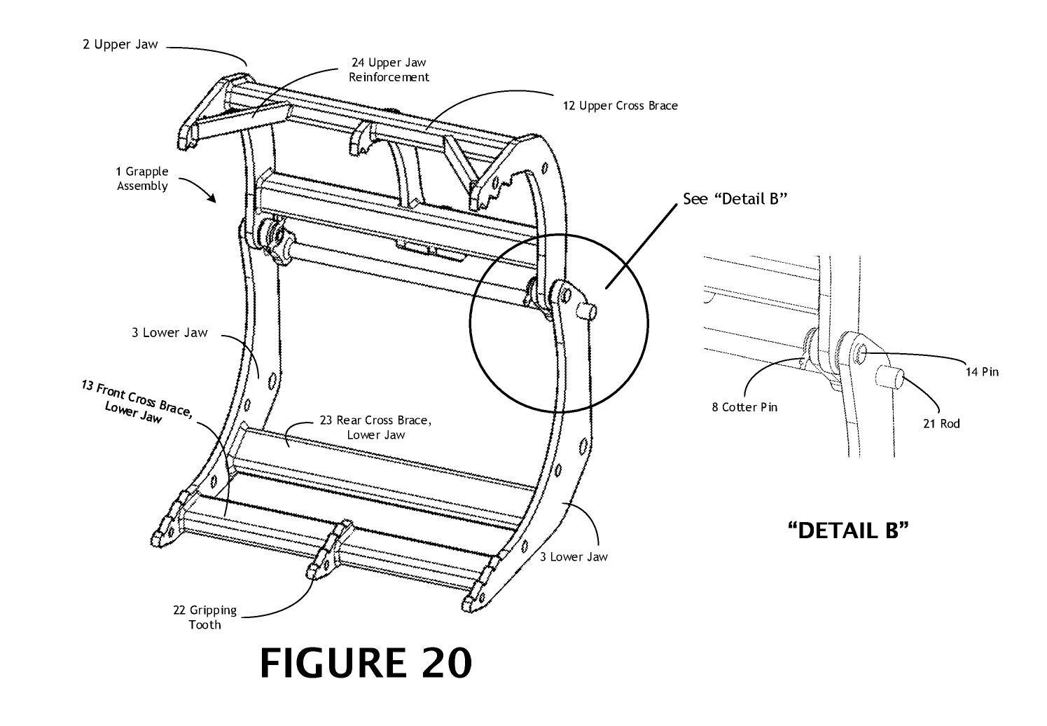

FIG. 20 depicts an assembly view of the grapple assembly of FIG. 1, the grapple assembly having the grapple jaws open. “DETAIL B” is an exploded view from FIG. 20 and depicts the pin detail pivotally connecting the upper jaw [2] to lower jaw 3.

One of the challenges of the present invention was being able to get the hydraulic cylinder [4] to not be crushed or have any binding during use due to the mounting location being on top of the quick hitch base. Not only was this overcome, but the original hydraulic cylinder [4] has a movement range of only 4″ and the pivot points of the grapple upper jaw [2] had to be set to work within the limited range, while having a full range of operation.

The grapple assembly [1] of the present invention can be used for a variety of uses ranging from clearing debris, moving falling trees, pieces of concrete, etc. The advantage to using the present invention is its use of the John Deere® quick hitch system. This eliminates the need for separate mount, while enabling the user to also use all of the other implements which are also made by third party manufacturers. By using the existing hydraulic cylinders of the quick hitch [7] many people who already own a quick hitch [7] already have half the components necessary, thus saving money while also reducing the amount of parts necessary to use the grapple assembly [1] of the present invention. The grapple assembly [1] of the present invention can also hold objects, such as tree limbs securely, for cutting into smaller sections. It also greatly reduces the amount physical work necessary to move various objects and transport them.

Throughout this application, various Patents and Applications are referenced by number and inventor. The disclosures of these documents in their entireties are hereby incorporated by reference into this specification in order to more fully describe the state of the art to which this invention pertains.

It is evident that many alternatives, modifications, and variations of the grapple assembly [1] of the present invention will be apparent to those skilled in the art in light of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

### PARTS LIST

1. Grapple Assembly
2. Upper Jaw
3. Lower Jaw
4A. Grapple Hydraulic Cylinder
4B. Hitch Hydraulic Cylinder
5. Grapple Cylinder Lower Mount
6. Grapple Cylinder Upper Mount
7. Quick Hitch
8. Cotter Pin
9. Hinge
10. Retractable Pin
11. Upper Mounting Slot
12. Upper Cross Brace
13. Front Cross Brace, Lower Jaw
14. Pin
15. Upper Side Plates
16. Lower Side Plates
17. Front Cross Brace, Upper Jaw
19. Center Cross Brace with Hydraulic Cylinder Attachment, Upper Jaw
20. Fastener Hole
21. Rod
22. Gripping Tooth
23. Rear Cross Brace, Lower Jaw
24. Upper Jaw Reinforcement
25. Object
26. Ground

I claim:

1. A grapple assembly for front mounting onto a quick hitch of a vehicle, said grapple assembly comprising:
an upper and a lower opposed jaw, said upper opposed jaw being pivotally rotatable and cooperatively engageable relative to said lower opposed jaw, said upper jaw being attached to said lower opposed jaw by one or more pins, said one or more pins enabling said upper opposed jaw to rotate relative to said lower opposed jaw, said one or more pins being engageable into a pair of slots disposed on each side of said quick hitch of said vehicle; and
a cylinder mount for securing onto said quick hitch, said cylinder mount engaging with a first end of a grapple hydraulic cylinder, a second end of said grapple hydraulic cylinder pivotally fastened to said upper opposed jaw;
whereby said upper opposed jaw has a fully opened position relative to said lower opposed jaw via said grapple hydraulic cylinder to grasp an object, said upper opposed jaw having a fully closed position relative to said lower opposed jaw via said grapple hydraulic cylinder when said object is grasped.

2. The grapple assembly of claim 1, wherein the grapple assembly utilizes the existing mounting provisions and hydraulic actuators of said quick hitch.

3. The grapple assembly of claim 1, further comprising a third pair of additional gripping surfaces, a first of said third pair of said additional gripping surfaces extending from said upper opposed jaw, a second of said third pair of said additional gripping surfaces extending from said lower opposed jaw.

4. The grapple assembly of claim 1, wherein said cylinder mount is compatible with said grapple hydraulic cylinder supplied with said quick hitch.

5. The grapple assembly of claim 1, further comprising a grapple hydraulic cylinder having two ends, a first end of said grapple hydraulic cylinder mounted to said cylinder mount, a second end of said mounting bracket secured to said upper opposed jaw, said grapple hydraulic cylinder adapted to pivot said upper jaw relative to said second lower opposed jaw, said fully opened position of said upper opposing jaw relative to said lower opposed jaw via grapple hydraulic cylinder for grasping said object, said fully closed position of said upper opposing jaw relative to said lower opposed jaw via grapple hydraulic cylinder for once said object is grasped.

6. The grapple assembly of claim 1, wherein said grapple assembly is mountable onto said quick hitch.

7. The grapple assembly of claim 1, wherein said lower opposed jaw remains essentially stationary relative to said quick hitch during said fully opening position and said fully closed position relative to said quick hitch.

8. The grapple assembly of claim 1, wherein said quick hitch includes a locking feature enabling a fastener to engage with said cylinder mount and lock a front section of said quick hitch, preventing said front section from rotating.

9. A grapple assembly for front mounting onto a quick hitch of a vehicle, said grapple assembly comprising:
an upper and a lower opposed jaw, said upper opposed jaw being pivotally rotatable and cooperatively engageable relative to said lower opposed jaw, said upper jaw being attached to said lower opposed jaw by one or more pins, said one or more pins enabling said upper opposed jaw to rotate relative to said lower opposed jaw, said one or more pins being engageable into a pair of slots disposed on each side of said quick hitch of said vehicle; and
a cylinder mount for securing onto said quick hitch, said cylinder mount engaging with a first end of a grapple hydraulic cylinder, a second end of said grapple hydraulic cylinder pivotally fastened to said upper opposed jaw, said quick hitch including a locking feature enabling a fastener to engage with said cylinder mount and lock a front section of said quick hitch, preventing said front section from rotating;
whereby said upper opposed jaw has a fully open position relative to said lower opposed jaw via said grapple hydraulic cylinder to grasp an object, said upper opposed jaw having a fully closed position relative to said lower opposed jaw via said grapple hydraulic cylinder when said object is grasped.

10. The grapple assembly of claim 9, further comprising a third pair of additional gripping surfaces, a first of said third pair of said additional gripping surfaces extending from said upper opposed jaw, a second of said third pair of said additional gripping surfaces extending from said lower opposed jaw.

11. The grapple assembly of claim 9, wherein said cylinder mount is compatible with said grapple hydraulic cylinder supplied with said quick hitch.

12. The grapple assembly of claim 9, further comprising a grapple hydraulic cylinder having two ends, a first end of said grapple hydraulic cylinder mounted to said cylinder mount, a second end of said mounting bracket secured to said upper opposed jaw, said grapple hydraulic cylinder adapted to pivot said upper jaw relative to said second lower opposed jaw, said fully opened position of said upper opposing jaw relative to said lower opposed jaw via grapple hydraulic cylinder for grasping said object, said fully closed position of said upper opposing jaw relative to said lower opposed jaw via grapple hydraulic cylinder for once said object is grasped.

13. The grapple assembly of claim 9, wherein said quick hitch includes structure for mounting said grapple assembly.

14. The grapple assembly of claim 9, wherein said lower opposed jaw remains essentially stationary relative to said quick hitch during said fully opening position and said fully closed position relative to said quick hitch.

15. A grapple assembly for front mounting onto a quick hitch of a vehicle, said grapple assembly comprising:
an upper and a lower opposed jaw, said upper opposed jaw being pivotally rotatable and cooperatively engageable relative to said lower opposed jaw, said upper jaw being attached to said lower opposed jaw by one or more pins, said one or more pins enabling said upper opposed jaw to rotate relative to said lower opposed jaw, said one or more pins being engageable into a pair of slots disposed on each side of said quick hitch of said vehicle;
a grapple hydraulic cylinder having two ends, a first end of said grapple hydraulic cylinder pivotally fastened to said upper opposed jaw, said grapple hydraulic cylinder adapted to pivot said upper jaw relative to said second lower opposed jaw; and
a cylinder mount for securing onto said quick hitch, said cylinder mount engaging with a second end of said grapple hydraulic cylinder; and
whereby said upper opposed jaw has a fully opened position relative to said lower opposed jaw via said grapple hydraulic cylinder to grasp an object, said upper opposed jaw having a fully closed position relative to said lower opposed jaw via said grapple hydraulic cylinder when said object is grasped.

16. The grapple assembly of claim 15, further comprising a third pair of additional gripping surfaces, a first of said third pair of said additional gripping surfaces extending from said upper opposed jaw, a second of said third pair of said additional gripping surfaces extending from said lower opposed jaw.

17. The grapple assembly of claim 15, wherein said cylinder mount is compatible with said grapple hydraulic cylinder supplied with said quick hitch.

18. The grapple assembly of claim 15, wherein said grapple assembly is mountable onto said quick hitch.

19. The grapple assembly of claim 15, wherein said lower opposed jaw remains essentially stationary relative to said quick hitch during said fully opening position and said fully closed position relative to said quick hitch.

20. The grapple assembly of claim 15, wherein said quick hitch includes a locking feature enabling a fastener to engage with said cylinder mount and lock a front section of said quick hitch, preventing said front section from rotating.
